(19) United States
(12) Patent Application Publication
(10) Pub. No.: US 2025/0028937 A1
(43) Pub. Date: Jan. 23, 2025

(54) METHOD FOR TRAINING A CONVOLUTIONAL NEURAL NETWORK COMPRISING NODES ARRANGED IN LAYERS AND A PRUNING MASK

(71) Applicant: Robert Bosch GmbH, Stuttgart (DE)

(72) Inventor: Cecilia Eugenia De La Parra Aparicio, Herrenberg (DE)

(21) Appl. No.: 18/772,334

(22) Filed: Jul. 15, 2024

(30) Foreign Application Priority Data
Jul. 18, 2023 (DE) 10 2023 206 789.7

(51) Int. Cl. G06N 3/0464; G06N 3/082; G06N 3/084; G06N 3/09

(52) U.S. Cl. CPC G06N 3/0464; G06N 3/082; G06N 3/084; G06N 3/09

(57) ABSTRACT

A computer implemented method for training a convolutional neural network including nodes arranged in layers and a pruning mask. The method includes: providing at least one set of labeled training data; initializing the convolutional neural network; passing the training data through the convolutional neural network; computing a loss function and comparing the loss function with the labels of the training data; and minimizing the loss function by backward propagation including determining a gradient of the loss function; wherein passing the training data through the pruning mask includes multiplying the structures of the input of the pruning mask with a pruning parameter, the pruning parameter for the structures being 0 or 1; wherein the pruning mask is approximated by an approximation function during backward propagation.

### CROSS REFERENCE

The present application claims the benefit under 35 U.S.C. § 119 of German Patent Application No. DE 10 2023 206 789.7 filed on Jul. 18, 2023, which is expressly incorporated herein by reference in its entirety.

### FIELD

The present invention relates to the field of training a convolutional neural network using structured pruning. This means that complete channels, i.e., input channels, output channels, filters, or other smaller structures for example half a filter, are removed from a convolutional layer of a convolutional neural network.

### BACKGROUND INFORMATION

A convolutional neural network (CNN) is a special type of neural networks. CNNs are a popular architecture for processing data with a spatial structure, such as images or audio signals.

The basic operation in a CNN is a convolution. A convolution is a mathematical operator that superimposes a function on another function to create a new function. In the context of CNNs, convolution refers to applying filters to input data to extract features.

A CNN consists of several layers, the most important of which are the convolutional layers. In these convolutional layers, filters or so-called “kernels” are used to extract local features from the input data. Each filter consists of a small matrix of weights that is pushed over the input data to perform a convolution. This convolution produces an activation map that represents the response of the filter to various features in the input signal.

Neural network compression is a key tool to enable a deployment in embedded devices. One of the most used compression methods is pruning, which consists of removing redundant or unnecessary elements of the neural network architecture. Pruning can be performed in unstructured and structured fashion.

Unstructured pruning removes single weights, which results in a high pruning ratio aka compression ratio. However, such an approach translates to irregular memory accesses and computations, which at the end do not bring any practical resource improvements in embedded hardware platforms.

Structured pruning, on the other hand, can effectively reduce computational resources by removing complete neural network structures such as channels. Traditional structured pruning methods eliminate structures according to a significance metric, for example the L1-norm. This pruning process is performed for each layer as follows: the structure-wise significance is computed iteratively while monitoring the neural networks' accuracy, until the accuracy tolerance or max. pruning ratio is reached.

Another structure pruning selection approach is presented in He et al., “Channel pruning for accelerating very deep neural networks,” CoRR, abs/1707.06168, 2017. In this method, at each layer, less significant structures are eliminated by LASSO regression. Then, the pruned layer is fine-tuned. These approaches are quite time-costly, as fine-tuning needs to be performed each time a layer is pruned. Additionally, this is not optimal because it considers the same pruning ratio for all layers, when there are some layers that are highly sensitive towards pruning and shouldn't even be compressed at all.

More modern methods consider training a so-called pruning mask. This mask has elements that are either 0 or 1, and each element multiplies the corresponding structure of the layer to be pruned. In Gao et al., “Discrete model compression with resource constraint for deep neural networks,” IEEE/CVF Conference on Computer Vision and Pattern Recognition (CVPR), pages 1896-1905, 2020, a method is proposed where the pruning mask is represented as a stochastic vector with values (0, 1) that is trained using Stochastic Gradient Descent (SGD) while the neural networks weights are frozen. The training is constrained by the target number of floating-point operations (FLOPs), and the regularization loss is a logarithmic loss R (x, y)=log (|x-y|+1), where x is the current number of FLOPs and y is the target number of FLOPs. This loss is added to the original cost function C of the target neural network model during the mask training. After the pruning mask has been trained, the neural network model is pruned with the resulting mask and is fine-tuned for some epochs to improve accuracy.

In Gao et al., “Disentangled differentiable network pruning,” In European Conference on Computer Vision, 2022, the authors determine the pruning mask of a target neural network model by using a smaller neural network model consisting of gated recurrent units (GRUs) or fully connected layers (FC) to learn structure-wise significance and layer-wise width (or number of structures). The pruning mask is hereby represented with a Smoothstep function to allow soft relaxation. The weights of the target neural network are frozen and the smaller neural network is trained. After the smaller neural network model has been trained and the pruning mask has been obtained, the target neural network is then fine-tuned to improve accuracy.

The first problem that current structure pruning methods pose is that they require a first optimization stage to obtain the pruning mask or to determine the structures to be pruned, and then require a second optimization stage to fine-tune the pruned model. While some methods use SGD to estimate the pruning mask, their proposed cost functions do not allow simultaneous training of the pruning mask and target neural network model. The second problem is that due to the sequential nature of pruning methods, it is not possible to perform joint optimization of pruning and other compression methods that require fine-tuning, for example quantization.

An object of the present invention is to provide a method for structured pruning, which does not require any modification of the cost function and that allows for neural network weights and masks to be trained at the same time to significantly reduce optimization time.

The problem may be solved by features of the present invention.

According to a first aspect, the present invention relates to a computer implemented method for training a convolutional neural network (CNN) comprising nodes arranged in layers and a pruning mask. According to an example embodiment of the present invention, the method comprises the following step:
providing at least one set of labeled training data;
initializing the convolutional neural network comprising at least one convolutional layer and a pruning mask behind said convolutional layer;
passing the training data through the convolutional neural network;
computing a loss function and comparing the loss function with the labels of the training data to quantify the convolutional neural networks process; and
minimizing the loss function by backward propagation, including determining a gradient of the loss function for determining a direction for optimizing the nodes of the convolutional neural network.

According to an example embodiment of the present invention, passing the training data through the pruning mask comprises multiplying the structures sᵢ of the input of the pruning mask with a pruning parameter Mᵢ, the pruning parameter Mᵢ for the structure's sᵢ being 0 or 1. The pruning mask is approximated by an approximation function during backward propagation.

The training data is provided in sets. For each set, the CNN generates one output. The output may comprise a statement about the input data, a characterization thereof, or the like. Furthermore, the providing of the training data may comprise any kind of preprocessing for processing the data by the CNN. This may include, without being limited to, scaling an input image, transforming wave-based data, like audio data, etc.

Labeling the training data is important, since the labels will indicate, whether the CNN processed the data correctly or not. If the data was not processed such that the CNN found the correct label as given with the provided training data sets, the parameters of the CNN are adjusted.

According to an example embodiment of the present invention, during initialization, the architecture of the CNN is defined. This includes the number of convolutional layers, pooling, layers, fully connected layers and activation functions. Then, the weights and biases of each neuron or node are initialized, which means they get a starting value, which may or may not be adjusted during the training.

When the training data is passed through the CNN, the data passes each layer one by one. The first layers to be passed through are convolutional layers to identify points of interest (POI) or regions of interest (ROI) in the data. If the input data is image data, the convolutional layers may identify a group of pixels to be analyzed by the CNN with high detail.

While the data is passed through each layer, each operation on the data is applied, like convolutions, poolings, or activation functions. Then, an activation map is generated. For example, each filter (convolutional layer) detects specific features or patterns in the input image. The convolution operation involves sliding the filter across the input spatially, computing element-wise multiplications and summations. This process produces a feature map that highlights the regions of the input image where the filter's features are detected.

The activation maps capture the learned representations at different levels of abstraction within the CNN. As the data passes through successive convolutional layers, the activation maps become increasingly complex, representing higher-level features. The earlier layers capture low-level features like edges and textures, while deeper layers learn more complex features like shapes, objects, or semantic concepts.

Activation maps provide valuable insights into how a CNN processes and understands the input data, by visualizing and interpreting the network's feature extraction capabilities.

According to an example embodiment of the present invention, the step of computing a loss function and comparing the loss-function with the labels of the training data to quantify the convolutional neural network process is the part of the backward pass or backward propagation of the training process. Thus, in CNNs, the loss function measures the discrepancy between the predicted output of the network and the true labels of the training data. It quantifies how well the network is performing in terms of its ability to correctly classify or predict the target outputs.

The choice of a suitable loss function depends on the specific task and the nature of the problem being addressed. Commonly used loss functions in CNNs may include a Mean Squared Error (MSE) or a cross entropy loss.

The MSE loss function calculates the average squared difference between the predicted and true labels. It is often used for regression problems. Cross-entropy loss measures the dissimilarity between the predicted class probabilities and the true labels. It is commonly used for classification tasks.

Choosing an appropriate loss function is important, as it influences the network's learning behavior and the optimization process. Different loss functions have different properties and are more suitable for specific tasks or data distributions. It is important to consider the characteristics of the problem at hand when selecting the appropriate loss function for training a CNN.

During backpropagation, the loss function is used to compute the gradient of the network's parameters with respect to the loss. This gradient provides information about the direction and magnitude of adjustments needed to minimize the loss. The gradient is then propagated backward through the network, allowing the weights and biases to be updated iteratively using optimization algorithms such as, but not limited to, Stochastic Gradient Descent (SGD).

The goal of training a CNN is to minimize the loss function by adjusting the network's parameters iteratively. As the network is trained on more data and the optimization progresses, the loss function should decrease, indicating an improvement in the network's predictive performance.

Considering only the filter dimension sₒᵤₜ, the proposed invention requires a pruning mask M which is a vector of length sₒᵤₜ. Mask values can either be 0 or 1. Such structured pruning can then be formulated as:

$${Y}_{q , p r u n e d} = {Y}_{q} ⋆ {M}_{q}$$

where q denotes the q-th structure. The cost function used to train the target CNN model is also used to optimize the pruning mask.

For the training's back-propagation, a gradient of this discrete function does not exist and therefore an approximation hast to be applied instead.

A possible approximation of the rounding function may be:

$${round}_{approx} ( {Z}^{′} ) = {Z}^{′} - \frac{sin ( 2 {π Z}^{′} )}{2 π}$$

Another possibility is to compute a steeper sigmoid and to remove the rounding function during back-propagation, which gives:

$${σ}_{steep} = \frac{1}{1 + {e}^{( - γ Z )}}$$

where γ regulates the steepness (larger γ results in steeper function).

The closer the approximation to the actual rounding function, the better the parameters will be updated after back-propagation.

By providing a pruning mask, which is trainable by the same cost function as the convolutional layers and an approximation function for the discrete function of the pruning mask, the CNN can be trained without modifying the cost function and thus, a pruning mask that can be trained at the same time with the remaining CNN to significantly reduce optimization time.

Therefore, the present invention solves the problem.

In an example embodiment of the present invention, the pruning parameter Mᵢ is determined from a helper vector Zᵢ, wherein the helper vector Zᵢ is a trainable parameter of the convolutional neural network, and wherein the approximation function is a function of Zᵢ.

As mentioned above, the mask can only have values of 0 or 1, which are discrete values and therefore may not be directly trained. To enable mask optimization, a helper vector Z can be used. The vector Z can then be regarded as an importance ranking of each filter q. The function max (Z) may be defined as the most important filter and min (Z) as the least important filter, respectively.

In another example embodiment of the present invention, the pruning parameter is derived from rounding a sigmoid function, wherein the helper vector Zᵢ is the input of the sigmoid function.

The dependency between M and Z may be expressed, for example, without being limited to, by:

$$M = round ( σ ( Z ) ) \\ with : 0 < {\sum }_{i} {M}_{i} \leq β * c {h}_{out}$$

wherein Z is a trainable parameter, σ(·) represents the sigmoid function and β is

$$\frac{1}{compression rate} .$$

The compression rate. The compression rate is defined as the number of weights before pruning divided by the number of weights after pruning. The sigmoid function is a possibility for the interpolation between [0,1] of the trainable vector Z.

In an example embodiment of the present invention, the helper vector Zᵢ is initialized with a value of 0 or close to 0. Values close to 0 may comprise values in the range of, e.g., 1e-4 or 1e-5.

Beneficially, by initializing Z with a value 0 or close to 0 may cause the mask Mᵢ to converge to either M=0 or M=1 faster. This automatically discerns important filters Z>0 from unimportant filters Z<0 by steering Z according to its direct impact on the main CNN cost function.

In an example embodiment of the present invention, the sum of all pruning parameters Mᵢ is greater than 0. In other words, the condition

$$0 < {\sum }_{i} {M}_{i}$$

is fulfilled.

By selecting the sum of all pruning parameters to be greater than 0 to fulfill this constraint, it is ensured that the most important filters will never be pruned. For example, the constraint may be realized by searching and replacing the largest element in Z and replacing it with a very small value, like 1e-4, if this element is smaller than 0.

In an example embodiment of the present invention, the sum of all pruning parameters Mᵢ is lower than or equal to the number of output structures of the convolutional layer sₒᵤₜ divided by the compression ratio of the pruning mask.

This constraint guarantees that at least k filters are pruned (k>0; guaranteed minimum compression rate). If any min-k element of Z is non-negative, a negative offset is applied, such that the resulting mask equals 0. By selecting the min-k elements, it is ensured that the least important filters are the ones being pruned.

In an alternative example embodiment of the present invention, the sum of all pruning parameters Mᵢ is lower or equal to a factor corresponding to hardware limitations of the destined operating system.

By including hardware limitations of the destined operating system, the CNN can be trained more effectively for or even on the destined system.

In an example embodiment of the present invention, the convolutional neural network is designed for processing image or audio data, especially being implemented as an eye tracking application.

The training for an eye tracking application could be structured, for example, without being limited to, like the following.

In a first step, eye-tracking data is collected using specialized eye-tracking equipment or sensors. This data typically includes information about the gaze position or eye movements of a user.

In a second step, the collected eye-tracking data is preprocessed to remove noise and artifacts. This may involve filtering, calibration, and normalization techniques to ensure the data quality.

Then, in a third step, the preprocessed eye-tracking data is combined with corresponding input images or visual stimuli. These input images serve as the input to the CNN, while the eye-tracking data acts as the ground truth or labels.

Next, in the fourth step, the CNN architecture is designed, which involves selecting suitable layers, filter sizes, pooling operations, and activation functions. The architecture should be tailored to the eye-tracking task at hand, taking into account factors such as input image resolution, eye movement patterns, and desired accuracy.

The CNN is trained using the created dataset. The input images are fed into the network, and the predicted gaze position or eye movement is compared with the ground truth labels. This is the layer in the CNN, in which the pruning may be applied. Regions of interest (ROI) or Points of Interest (POI) may be selected, wherein the other regions of the input data are pruned. The difference between the predicted and actual eye movements is used to compute a loss function.

In the next, sixth step, backpropagation is performed to update the weights and biases of the CNN based on the computed loss. The gradient of the loss function with respect to the network parameters is calculated, and the weights are adjusted using optimization algorithms. The pruning mask may be approximated by a suited function like the ones mentioned above.

Then, the trained CNN is evaluated on a separate validation dataset to assess its performance. Hyperparameters such as learning rate, batch size, and network architecture may be tuned to improve the model's accuracy and generalization ability.

Once the CNN is trained and validated, it can be used for eye-tracking predictions on new, unseen data. The input images are fed into the trained network, and the CNN generates predictions of gaze positions or eye movements. The output of the CNN can be post-processed and visualized to provide meaningful insights. This may involve mapping the predicted gaze positions onto the input images or generating heatmaps to highlight areas of visual attention.

Lastly, the performance of the eye-tracking CNN can be further improved through iterative cycles of training, validation, and fine-tuning. This may involve collecting more data, refining the network architecture, or incorporating additional techniques such as data augmentation or regularization. However, this step may be shortened due to the trainable pruning mask layer.

In another aspect, the present invention relates to a computer program comprising program code for running a computer implemented method as described above, when the computer program is run on a computer.

In yet another aspect, the present invention relates to a computer readable data carrier comprising program code of a computer program to run a computer implemented method as described above, if the computer program is run on a computer.

In yet another aspect, the present invention relates to a system for training a convolutional neural network using a pruning mask, wherein the system comprises means for running a computer implemented method as described above.

The described embodiments and further developments can be combined with each other as desired.

Further possible embodiments, further developments and implementations of the present invention also include combinations, not explicitly mentioned, of features of the present invention described before or below with respect to the embodiments.

### BRIEF DESCRIPTION OF THE DRAWINGS

The figures are intended to provide a further understanding of example embodiments of the present invention. They illustrate embodiments and, in connection with the description, serve to explain principles and concepts of the present invention.

Other embodiments and many of the advantages mentioned will be apparent with reference to the figures. The elements shown in the figures are not necessarily shown to scale with respect to each other.

FIG. 1 shows a schematic view of the method according to an example embodiment of the present invention.

FIG. 2 shows a schematic illustration, showing the principle of the present invention.

FIG. 3 shows a sigmoid function as it may be used for the present invention.

FIG. 4 shows different functions as they may be used according to the present invention.

In the figures, identical reference signs denote identical or functionally identical elements, parts or components, unless otherwise indicated.

### DETAILED DESCRIPTION OF THE EXAMPLE EMBODIMENTS

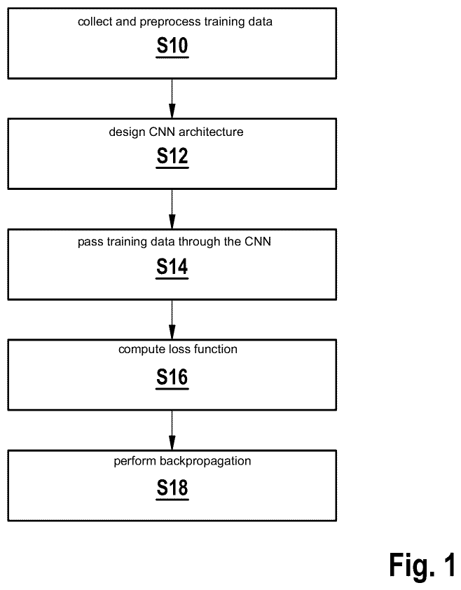

FIG. 1 shows a schematic view of a method according to an embodiment of the present invention.

In a first step S10, training data is collected and preprocessed to remove, for example, noise and artifacts. This may involve filtering, calibration, and normalization techniques to ensure the data quality. The preprocessed training data is labeled, which is needed to find the ground truth or to identify a correct processing of data by the CNN.

In step S12, the CNN architecture is designed, which involves selecting suitable layers, filter sizes, pooling operations, and activation functions. The design of the CNN also includes initializing the values, weights, and biases of each node within the CNN.

In step S14, the training data is passed through the CNN. The input images are fed into the network, and the network finds predictions for each training set. Said prediction will be more or less correct when compared with the labels.

The difference between the predicted and actual labels is used to compute a loss function in step S16. The loss function is the core element of the training process because it is used to refine the weights, biases, and values for each node in the network.

In step S18, backpropagation is performed to update the weights and biases of the CNN based on the computed loss. The gradient of the loss function with respect to the network parameters is calculated, and the weights are adjusted using optimization algorithms. The pruning mask may be approximated by a suited function, like a sigmoid function.

The steps S14 to S18 may be repeated, until the loss function has a sufficiently low value.

Then, the trained CNN is evaluated on a separate validation dataset to assess its performance. Hyperparameters such as learning rate, batch size, and network architecture may be tuned to improve the model's accuracy and generalization ability.

Once the CNN is trained and validated, it can be used for original purposes on new, unseen data. The input data is fed into the trained network, and the CNN generates predictions according to its policy. The output of the CNN can be post-processed and visualized to provide meaningful insights. This may involve mapping the output over relevant parameters or generating heatmaps to highlight areas of visual attention.

Lastly, the performance of the CNN can be further improved through iterative cycles of training, validation, and fine-tuning. This may involve collecting more data, refining the network architecture, or incorporating additional techniques such as data augmentation or regularization. However, this step may be shortened due to the applying a pruning mask, which can be trained with the remaining layers of the CNN.

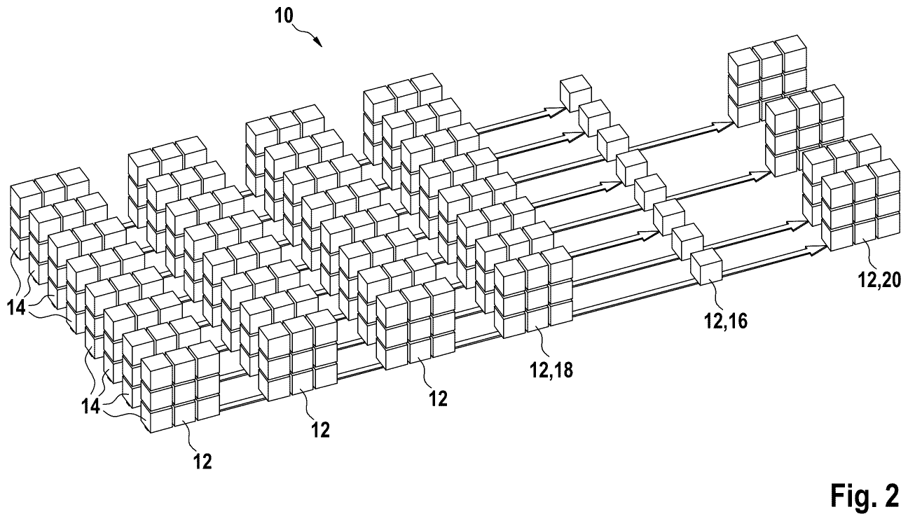

FIG. 2 shows a schematic illustration of a pruned CNN 10. The CNN may comprise multiple layers 12, each layer having multiple structures 14. In each layer 12, each structure 14 can be processed.

However, one of the shown layers 12 is a pruning mask 16. The structures 14 of the pruning mask 16 are set up to multiply the output from a layer 18 in front of the pruning mask 16 with a pruning parameter M. Thus, the output of a structure sᵢ is multiplied with the pruning parameter Mᵢ corresponding to said structure 14.

The pruning parameter Mᵢ may be 1 for passing the structure's output if the layer 18 as input to a layer 20 beyond the pruning mask. Otherwise, the pruning parameter may be 0 to prune a structure 14. In FIG. 2, four structures 14 are shown to be pruned, while another four structures 14 are shown to pass the structure output of layer 18 as structure input to layer 20.

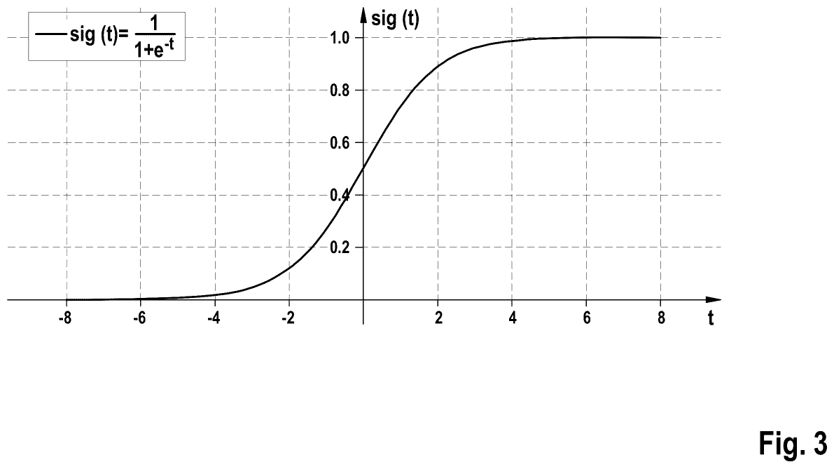

FIG. 3 shows the graph of a sigmoid function. The shown function is:

$$sig ( t ) = \frac{1}{1 + {e}^{- t}} .$$

When rounded, the function round (sig (t)) will give values of 1for each t greater or equal to 0 and values of 0 for each t lower than 0. When t is substituted with the helper vector Z, it can give values of 1 or 0 depending on said helper vector Z.

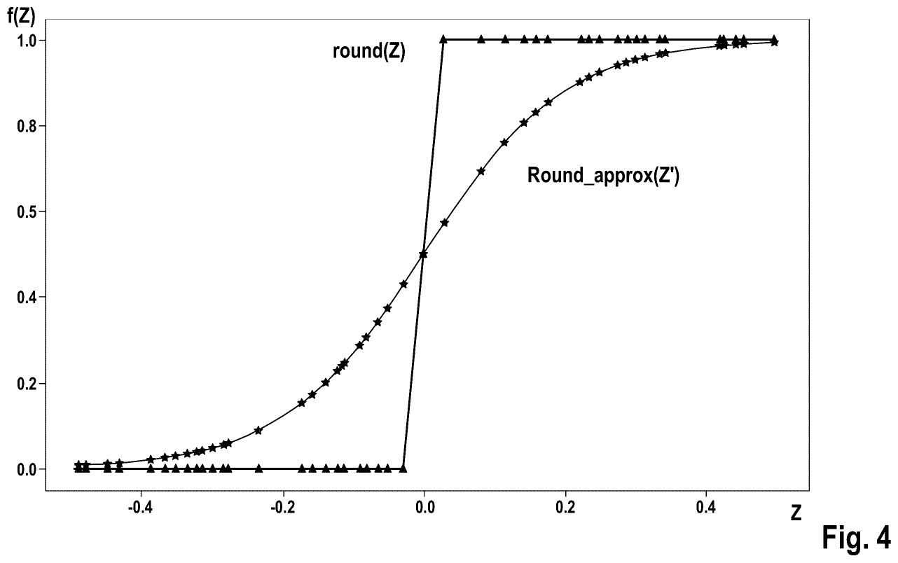

FIG. 4 shows two functions for f (Z), wherein Z is the helper vector. One of the functions f (Z) is the round-function round (Z), which gives values of 1 for positive Z and values of 0 for negative Z. This function may be used to determine a pruning parameter for which Z is the corresponding parameter to be trained in the CNN.

The round-function does not have a gradient because it is not a continuous function. It switches from 0 to 1 at Z=0, which results in a differential of infinity. But for training Z, a gradient has to be derived for checking if Z must be raised or lowered.

The gradient function for the round function is approximated by an approximation function, which may be

$${round}_{approx} ( {Z}^{′} ) = {Z}^{′} - \frac{sin ( 2 π {Z}^{′} )}{2 π} .$$

As shown in FIG. 4, roundₐₚₚᵣₒₓ (Z′) is a continuous function, from which a gradient can be derived.

The combination of both functions enables a trainable pruning mask for a CNN. One function is for forward propagation, and the other may be applied during backward propagation.

What is claimed is:

1. A computer implemented method for training a convolutional neural network including nodes arranged in layers and a pruning mask, the method comprising the following steps:
providing at least one set of labeled training data;
initializing the convolutional neural network including at least one convolutional layer and a pruning mask following the convolutional layer;
passing the training data through the convolutional neural network;
computing a loss function and comparing the loss function with labels of the training data to quantify the convolutional neural networks process; and
minimizing the loss function by backward propagation including determining a gradient of the loss function for determining a direction for optimizing the nodes of the convolutional neural network;
wherein the passing of the training data through the pruning mask includes multiplying structures sᵢ of input of the pruning mask with pruning parameters Mᵢ, the pruning parameters Mᵢ for the structures sᵢ being 0 or 1;
wherein the pruning mask is approximated by an approximation function during backward propagation.

2. The computer implemented method according to claim 1, wherein the pruning parameters Mᵢ are determined from a helper vector Zᵢ, wherein the helper vector Zᵢ is a trainable parameter of the convolutional neural network, and wherein the approximation function is a function of the helper vector Zᵢ.

3. The computer implemented method according to claim 2, wherein the pruning parameters Mᵢ are derived from rounding a sigmoid function, wherein the helper vector is input of the sigmoid function.

4. The computer implemented method according to claim 3, wherein the helper vector Zᵢ is initialized with a value of 0 or close to 0.

5. The computer implemented method according to claim 1, wherein a sum of all pruning parameters Mᵢ is greater than 0.

6. The computer implemented method according to claim 1, wherein: (i) a sum of all pruning parameters Mᵢ is lower than or equal to a number of output structures of the convolutional layer sₒᵤₜ divided by a compression ratio of the pruning mask, or (ii) the sum of all pruning parameters Mᵢ is lower or equal to a factor corresponding to hardware limitations of a destined operating system.

7. The computer implemented method according to claim 1, wherein the convolutional neural network is configured for processing image or audio data.

8. The computer implemented method according to claim 1, wherein the convolutional neural network is configured as an eye tracking application.

9. A non-transitory computer readable data carrier on which is stored program code of a computer program for training a convolutional neural network including nodes arranged in layers and a pruning mask, the program code, when executed by a computer, causing the computer to perform the following steps:
providing at least one set of labeled training data;
initializing the convolutional neural network including at least one convolutional layer and a pruning mask following the convolutional layer;
passing the training data through the convolutional neural network;
computing a loss function and comparing the loss function with labels of the training data to quantify the convolutional neural networks process; and
minimizing the loss function by backward propagation including determining a gradient of the loss function for determining a direction for optimizing the nodes of the convolutional neural network;
wherein the passing of the training data through the pruning mask includes multiplying structures sᵢ of input of the pruning mask with pruning parameters Mᵢ, the pruning parameters Mᵢ for the structures sᵢ being 0 or 1;
wherein the pruning mask is approximated by an approximation function during backward propagation.

10. A system for training a convolutional neural network using a pruning mask, wherein the system comprising:
a computer configured to train a convolutional neural network including nodes arranged in layers and a pruning mask, the computer configured to:
provide at least one set of labeled training data,
initialize the convolutional neural network including at least one convolutional layer and a pruning mask following the convolutional layer,
pass the training data through the convolutional neural network,
compute a loss function and comparing the loss function with labels of the training data to quantify the convolutional neural networks process, and
minimize the loss function by backward propagation including determining a gradient of the loss function for determining a direction for optimizing the nodes of the convolutional neural network,
wherein the passing of the training data through the pruning mask includes multiplying structures sᵢ of input of the pruning mask with pruning parameters Mᵢ, the pruning parameters Mᵢ for the structures sᵢ being 0 or 1,
wherein the pruning mask is approximated by an approximation function during backward propagation.
